(19) United States
(12) Patent Application Publication
(10) Pub. No.: US 2012/0095741 A1
(43) Pub. Date: Apr. 19, 2012

(54) Predicting Downhole Formation Volumetric Sand Production Using Grain-Scale Rock Models

(75) Inventors: Guodong Jin, Katy, TX (US); Songhua Chen, Katy, TX (US); Jiansheng Chen, Sugar Land, TX (US)

(73) Assignee: BAKER HUGHES INCORPORATED, Houston, TX (US)

(21) Appl. No.: 13/272,602

(22) Filed: Oct. 13, 2011

Related U.S. Application Data
(60) Provisional application No. 61/393,201, filed on Oct. 14, 2010.

(51) Int. Cl. G06G 7/48

(52) U.S. Cl. 703/9

(57) ABSTRACT

A method, apparatus and computer-readable medium for estimating sand production from an earth formation is disclosed. A grain-scale formation model of the earth formation is created, wherein a value obtained from the grain-scale formation model compares to a value of a measured property of the earth formation. A fluid parameter of the grain-scale formation model is determined and a movement of at least one grain of the grain-scale formation model is determined due to the determined fluid parameter. The sand production is estimated from the determined movement of the at least one grain.

### CROSS-REFERENCE TO RELATED APPLICATIONS

The present application claims priority to U.S. Provisional Application Ser. No. 61/393,201, filed Oct. 14, 2010.

### BACKGROUND OF THE DISCLOSURE

Prediction of sand production from a formation during fluid recovery (for example, hydrocarbons) is important in evaluating the necessity of sand control in an unconsolidated or poorly-consolidated formation. Such predictions also assist in selecting a particular sand control technique. Two fundamental processes together lead to sand production: rock failure through which cement bonds between grains in a formation are broken and disjoint grains are generated, and transport of these disjoint grains by a fluid from the formation into a borehole. Most existing sand-production prediction models concentrate on determining sand production due to rock failure and therefore can only determine the conditions for the onset of sand production. The present disclosure provides a method of predicting a rate and volume of sand production in a borehole penetrating a formation.

### SUMMARY OF THE DISCLOSURE

Therefore, the present disclosure provides in one embodiment a method of estimating sand production from an earth formation, which includes: creating a grain-scale formation model of the earth formation, wherein a value obtained from the grain-scale formation model compares to a value of a measured property of the earth formation; determining a fluid parameter of the grain-scale formation model; determining a movement of at least one grain of the grain-scale formation model due to the determined fluid parameter; and estimating the sand production from the determined movement of the at least one grain.

In another embodiment, the present disclosure provides an apparatus for estimating sand production from an earth formation. The exemplary apparatus includes a sensor configured to measure a property of the earth formation and a processor that: creates a grain-scale formation model of the earth formation, wherein a value obtained from the grain-scale formation model compares to a value of the measured property, determines a fluid parameter of the grain-scale formation model, determines a movement of at least one grain of the grain-scale formation model due to the determined fluid parameter, and estimates the sand production from the determined movement of the at least one grain.

In another embodiment, the present disclosure provides a computer-readable medium having stored thereon instructions that when read by at least one processor enable the at least one processor to perform a method, the method comprising: creating a grain-scale formation model of an earth formation, wherein a value obtained from the grain-scale formation model compares to a value of a measured property of the earth formation; determining a fluid parameter of the grain-scale formation model; determining a movement of at least one grain of the grain-scale formation model due to the determined fluid parameter; and estimating the sand production from the determined movement of the at least one grain.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 shows an exemplary logging system used in a borehole to obtain measurements related to a property of a surrounding earth formation;

FIG. 2 illustrates an exemplary grain-scale formation model suitable for use in determining a sand production volume using the methods of the present disclosure;

FIG. 3 shows a flowchart for an exemplary coupled fluid-flow/grain-transport model for estimating a rate and volume of sand production;

FIG. 4 shows a flowchart of an exemplary method of the present disclosure for determining a rate of sand production;

FIG. 5 shows a flowchart of an exemplary method of the present disclosure for determining an onset of sand production;

FIG. 6 shows an exemplary formation model for determining an onset of sand production using the exemplary method of FIG. 5;

FIG. 7A shows an exemplary three-dimensional model of a formation for determining a sand production size distribution; and

FIG. 7B shows an chart of a grain size distribution obtained using the exemplary model of FIG. 7A.

### DETAILED DESCRIPTION OF THE DISCLOSURE

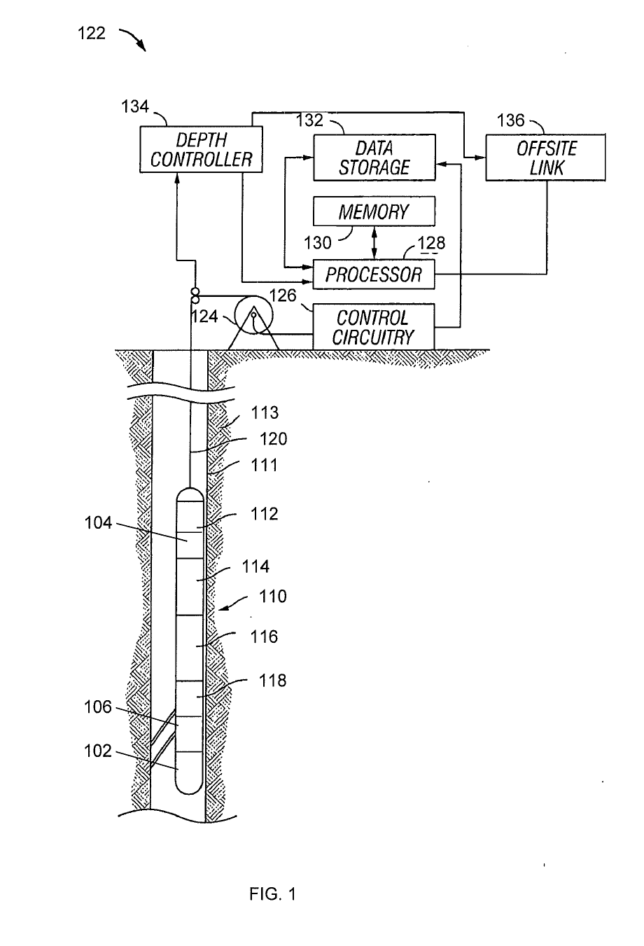

The present disclosure provides a method of estimating a rate and volume of sand production from a formation and uses a formation model based on measured properties of the formation. An exemplary system for obtaining such measurements is discussed with respect to FIG. 1. FIG. 1 shows an exemplary logging system used in a borehole to obtain measurements related to a property of a surrounding earth formation. The borehole can include a cased portion and/or an open hole portion. Shown in FIG. 1 is a suite of logging instruments 110 disposed within a borehole 111 penetrating the earth formation 113, illustrated in vertical section, and coupled to equipment at the earth's surface in accordance with the method and apparatus. In one embodiment, the formation is an unconsolidated or poorly-consolidated formation. Logging instrument suite 110 can include one or more devices referred to as formation evaluation (FE) sensors used in the borehole for logging operations. Among others, the formation evaluation sensors can include resistivity sensors for determining the formation resistivity and dielectric constant, acoustic sensors for determining the acoustic porosity of the formation and the bed boundary in the formation, nuclear sensors for determining the formation density, neutron porosity and certain formation characteristics, nuclear magnetic resonance sensors for determining the porosity and other petrophysical characteristics of the formation. It should be understood that the term formation evaluation sensor encompasses measurement devices, sensors, and other like devices that, actively or passively, collect data about the various characteristics of the formation, directional sensors for providing information about the tool orientation and direction of movement, formation testing sensors for providing information about the characteristics of the reservoir fluid and for evaluating the reservoir conditions. Direction and position sensors, including a combination of one or more accelerometers and one or more gyroscopes or magnetometers, can be used to provide direction and position measurements along three axes. Although the disclosure is discussed with respect to a wireline apparatus, this is not intended to be a limitation of the disclosure. Measurement-while-drilling and logging-while drilling apparatuses can also be used. In one embodiment, the formation evaluation sensors can collect formation fluid samples and determine a property of the formation fluid to yield a formation property such as formation pressure.

Exemplary formation evaluation sensors can include a resistivity device 112, a natural gamma ray device 114, porosity-determining devices, such as a neutron device 116 and a density device 118, a Nuclear Magnetic Resonance (NMR) device 106, an acoustic device 104 for obtaining acoustic or seismic logs, and/or a core sampling device 102 for obtaining and performing tests and evaluations of core samples. In addition, the logging instruments can include devices for performing micro-frac and leak-off tests. A downhole processor can be provided at a suitable location as part of the instrument suite.

Instrument suite 110 is conveyed within borehole 111 by a cable 120 containing electrical conductors (not illustrated) for communicating electrical signals between instrument suite 110 and the surface electronics, indicated generally at 122, located at the earth's surface. Logging devices 102, 104, 106, 112, 114, 116 and 118 within instrument suite 110 are cooperatively coupled such that electrical signals can be communicated between each device 102, 104, 106, 112, 114, 116 and 118 and surface electronics 122. Cable 120 is attached to a drum 124 at the earth's surface in a manner familiar to the art. Instrument suite 110 is caused to traverse borehole 111 by spooling cable 120 on to or off of drum 124, also in a manner familiar to the art.

Surface electronics 122 can include such electronic circuitry as is necessary to operate devices 102, 104, 106, 112, 114, 116 and 118 within instrument suite 110 and to process the data therefrom. Control circuitry 126 contains such power supplies as are required for operation of the chosen embodiments of logging devices within instrument suite 110 and further contains such electronic circuitry as is necessary to process and normalize the signals from such devices 102, 104, 106, 112, 114, 116 and 118 in a conventional manner to yield generally continuous records, or logs, of data pertaining to the formations surrounding borehole 111. In one aspect, these logs can then be electronically stored in data storage 132 prior to further processing.

Processor 128 can be of various forms but typically is an appropriate digital computer programmed to process data from logging devices 102, 104, 106, 112, 114, 116 and 118. Memory unit 130 and data storage unit 132 are each of a type to cooperatively interface with processor 128 and/or control circuitry 126. Depth controller 134 determines the longitudinal movement of instrument suite 120 within borehole 111 and communicates a signal representative of such movement to processor 128. Offsite communication can be provided, for example by a satellite link, by the telemetry unit 136. In addition, the processor 128 can be used to determine a formation model from the obtained geologic data and determine a rate of sand production from the obtained formation model using the exemplary methods described herein. Results of these calculations can be stored to memory unit 138 or sent to a display for use by an operator in selecting a suitable sand screen, for example.

In one embodiment, the present disclosure uses a grain-scale formation model of the formation based on one or more measurements of a formation property or properties made by one or more exemplary FE sensors of FIG. 1. In an exemplary embodiment, a grain-scale formation model of an earth formation for a depth of interest is constructed numerically using the formation properties directly or indirectly determined from downhole measurements, core images and/or core measurements. Exemplary formation properties can include, for example, porosity, grain mineralogy, cement, grain size distribution. Porosity can be determined by various obtained measurements, such as measurements from formation evaluation (FE) sensors, density sensors, Nuclear Magnetic Resonance (NMR) sensors (as NMR total porosity), or by a measurement of core samples. Grain size distribution can be determined by various measurements from FE sensors, such as NMR sensors or acoustic sensors, or through a sieve analysis of core samples. An amount of quartz cement can be determined by FE sensors, core images and/or by laboratory core analysis. Water saturation can be determined using downhole FE data, for example, NMR diffusivity contrast data. Weight percentages of minerals can be obtained from FE sensor data, core images and/or core analysis.

Additional formation properties can also be determined. Overburden and pore pressures can be determined by FE sensors, such as density/acoustic logs, geophysical logs, seismic data or formation test, for example. Maximum and minimum horizontal stress can be determined by FE sensors, such as acoustic log, micro-frac or leak-off tests, for example. When more than one fluid phase occupies a pore space, a direction of fluid displacement (i.e. drainage or imbibition) can be determined. When mineral composition is given as weight percentages, a density of each mineral can be specified and/or two elastic moduli (for example, bulk modulus and shear modulus) of each mineral can be additionally determined such as by using FE sensors, mud log, or laboratory analysis of cuttings or core sample. When multiple phases (i.e. water/oil/gas) occupy a pore space, density and bulk modulus of each phase can be determined.

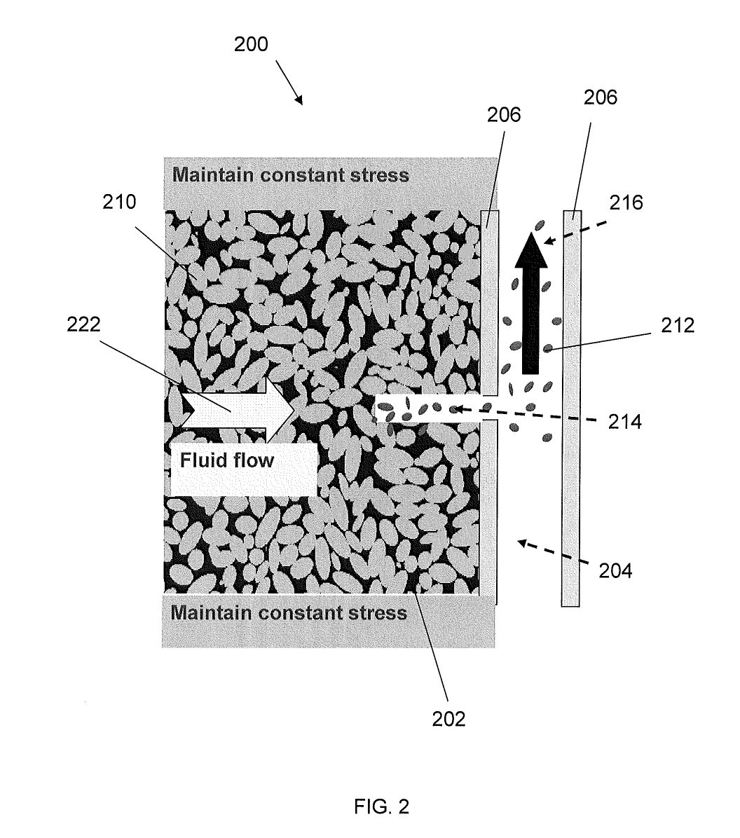

FIG. 2 illustrates an exemplary grain-scale formation model 200 suitable for use with the present disclosure. The exemplary formation model 200 includes a formation matrix 202 having a plurality of grains 210 which have a selectable distribution of grain sizes and grain shapes. In various aspects, the grain shapes can be spherical and/or ellipsoidal. More complex, irregularly shaped grains can also be created from the spheres and/or ellipsoids via a clustering technique in which grains bond together to form a rigid assemblage. The exemplary formation model 200 can have one or more perforations such as exemplary perforation 214. Grains can detach from the formation matrix 202 and the detached grains 212 can migrate into a nearby borehole 204 via the perforation 214. In an alternate embodiment, gravel packing can be incorporated into the formation model. The exemplary method is capable of simulating grain-fluid systems at a granular scale and resolving the interactions of individual solid grains with other solid grains and the surrounding fluid. Additionally, the exemplary method can capture the physics of microcracking, disaggregation, and grain movement around a perforation.

In one embodiment, a grain-scale formation model can be constructed numerically for a given depth or plurality of depths of the formation. A grain-scale formation model generally includes representative elastic formations with variable grain size distributions and grain shapes. The exemplary formation model can be built through simulation of dynamic geologic processes of grain sedimentation and compaction which can be followed by a simulation of a cementation process. Exemplary methods for obtaining an exemplary grain-size formation model are discussed in U.S. Pat. No. 7,257,490 by Georgi et al. and U.S. Pat. No. 7,363,161, by Georgi et al., the contents of which are incorporated by reference in their entirety.

Sedimentation and compaction processes can be simulated by a simulation of gravity, contact forces, hydrodynamic forces from fluid flow, and frictional forces between neighboring grains and surrounding fluids. In one embodiment, the sedimentation process is simulated using a “generate-settle” simulation, and the compaction process is modeled by simulating an applied overburden pressure on the formation model, which is typically confined by pressures from the sides and from below. In another embodiment, diagenesis (or post-sedimentation changes such as physical, chemical and/or biological) can be modeled numerically using a diagenetic rock transformation simulation. The simulated diagenesis provides for the effect of grain size under different deposition environments about the spatial distribution of cement. In one aspect, the formation model simulates geological depositional processes and sand production processes by imparting grains with various motions, such as translation and rotation. The simulated grains can collide and rebound with neighboring simulated grains.

To obtain a suitable formation model, a generated value for a geological property can be produced using a selected formation model. The generated value can be compared to a value of a geologic property obtained from the formation using the exemplary formation evaluation sensors of FIG. 1. Various parameters of the selected formation model can then be adjusted so that the generated value from the formation model is in substantially agreement with the value of a property obtained from the formation. In general, this process is performed to obtain a formation model that substantially represents the formation. Exemplary geologic properties can include one or more of porosity, grain size distribution, an amount of quartz cement, a water saturation, a direction of fluid displacement, mineral density, elastic moduli (for example, bulk modulus and shear modulus), phase density and bulk modulus, overburden and pore pressures, and maximum and minimum horizontal stress. In an alternate embodiment, the grain-scale formation model is made using well logging data acquired by at least four types of sensors and/or cutting analysis or core analysis data. The well logging data can include porosity measurements, mineral quantitation and NMR log data, for example.

Once a suitable grain-scale formation model is obtained, a fluid-flow model and a grain-transport model are used to determine a rate and volume of sand production. In various aspects, the fluid-flow model and grain-transport model are coupled. In various embodiments, the coupled fluid-flow/grain-transport model can be in two dimensions or three dimensions. The grain-transport model can be used to determine a motion of grains under various conditions such as flow conditions, pressure and saturation conditions and subsequently grain flow boundaries. The fluid-flow model can be used to determine various fluid parameters such as pressure/velocity fields and subsequently hydrodynamic forces. The grain flow boundaries determined from the grain-transport model can be used as input to the fluid-flow model, and the calculated hydrostatic forces resulting from the fluid-flow model can be used as input to the grain-transport model. Sand grains of the formation model, depending on their sizes and stress, can be transported out of the formation model by fluid flow entering into perforation tunnels and/or adjacent borehole. The sand production volume can be determined as a function of one or more of time, stresses, and hydrocarbon flow rate, and completion schemes.

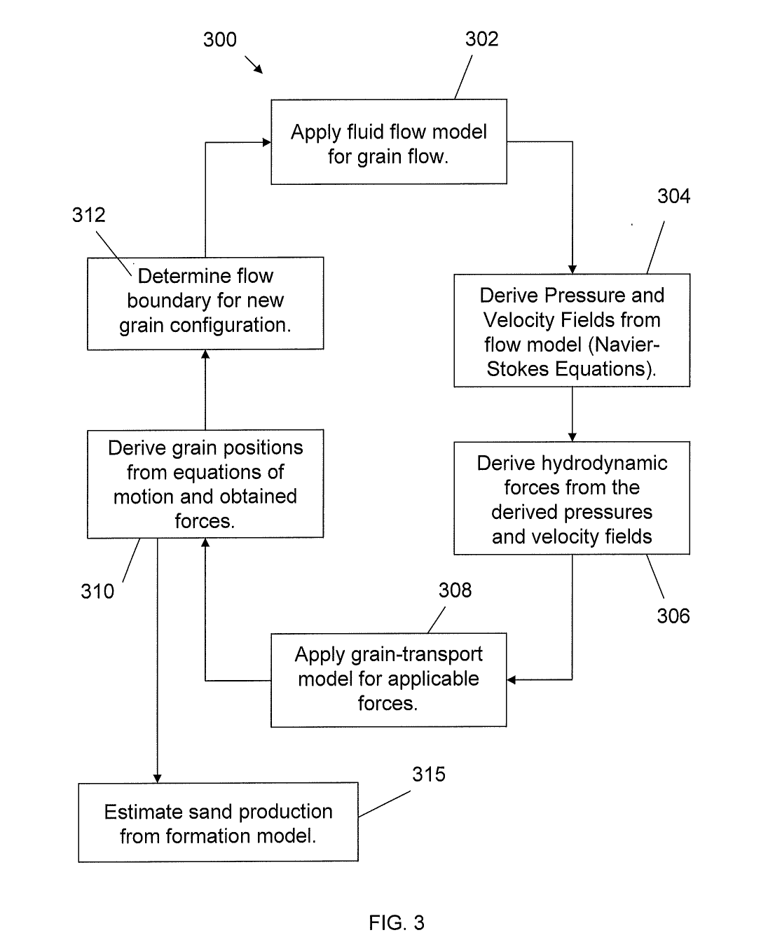

FIG. 3 shows an exemplary flowchart for a coupled fluid-flow/grain-transport model for predicting a rate and volume of sand production. The flowchart provides an iterative process between a grain-transport model (Box 308) and a fluid flow model (Box 302). The grain-transport model (Box 308) is used to determine movement, positions and orientations (Box 310) of individual grains from forces applied to grains of the formation model. The grains determined in Box 310 are used to determine a flow boundary of the grains (Box 312). The flow boundary and new positions of the grains are used as input to the fluid-flow model to determine a fluid pressure and velocity fields (Box 304). These resultant pressures and velocity field can be used to obtain a hydrostatic force (Box 306) usable at the grain-transport model. The various aspects of flowchart 300 are discussed below.

The application of a grain-transport model is now discussed. Once a suitable formation model is selected, a grain-transport model (Box 308) can be applied to the formation model to obtain a grain position for the individual grain particles and a grain flow boundary for the ensemble of grains. Motion of the individual grains can be simulated by applying one or more equations of motion from Newtonian mechanics to an ensemble of grains of the formation model. In one embodiment, the equations of motion can be applied using a distinct element method which takes into account the grain shapes along the forces and their moments acting on grains. Typical equations of motion for individual grains are:

$${m}_{i} {\ddot{x}}_{i} = {\sum }^{ } {F}_{i}^{b} + {\sum }_{j }^{ } ( {F}_{ij}^{c} + {F}_{ij}^{ca} ) + {F}_{i}^{dm} + {F}_{i}^{h} \\ {I}_{i} {\ddot{θ}}_{i} = {\sum }^{ } {M}_{i}^{b} + {\sum }_{j}^{ } {M}_{ij}^{c} + {M}_{i}^{dI} \qquad Eq . ( 1 )$$

where mᵢ and Iᵢ are the mass and moment of inertia of an i^{th} grain; xᵢ and θᵢ are the position vector of the i^{th} grain's centroid and the angle vector of rotation about the centroid, respectively; and the \ddot{x}ᵢ and \ddot{θ}ᵢ denote second-order time derivatives of the position and rotation angle, respectively. Forces acting on the body are: (i) body force Fᵢ^{b} from gravity and other external applied forces on the grain; (ii) contact force Fᵢⱼ^{c} at the contacts between grains i and j; (iii) capillary bonding force Fᵢⱼ^{ca} at the contacts between grains when multiple-phase fluids present in the pore space; (iv) damping force Fᵢ^{dm}, resulting from the movement of a grain in a viscous fluid; and (v) hydrodynamic force Fᵢ^{h} from the fluid flow and pore pressure. Moments acting on the grain are: (i) moment Mᵢⱼ^{c} resulting from tangential component of the contact force; (ii) external moment Mᵢ^{b} acting on the grain; and (iii) viscous damping moment Mᵢ^{dl} resulting from the rotation of the grain in a viscous fluid. The resultant force acting on a grain is a vector sum of the forces acting on the grain. Similarly, the resultant moment for a grain is a vector sum of the moments acting on the grain. The applied equations of motion yield a new position and orientation of the grains of the formation model (Box 310).

In one embodiment, the Newtonian equations of motion can be solved using a suitable method such as discrete element methods (DEM). DEM simulates the dynamic interactions of discrete grains according to Newtonian mechanics. It takes into account the grain shapes, along with the forces and moments experienced by the grains. In DEM models, cementation between grains can be modeled as contact bonds between grains, which have a linear elastic response up to the threshold normal strength or shear strength at which it breaks, thereby simulating grain detachment in one aspect. Coalescence of microscopic failures into a through-going shear plane can be reproduced. DEM simulations can further reproduce a sediment stress-strain behavior and simulate coupled dynamics in three dimensions.

A grain flow boundary (Box 312) can be determined from the new positions and orientations of the grains. Individual sand grains can move within and between the pores of the formation and/or gravel pack depending on their sizes and forces resulting from fluid flow and neighboring grains. Depending on flow conditions (e.g., high fluid velocity and/or water breakthrough), sand grains can cause a change in flow characteristics (for example, permeability and pore pressure) in the formation model such as by plugging a formation matrix or a sand control system, for example. Local displacements of these grains therefore cause changes in the local porosity field and consequently lead to new flow field characteristics. Pressures within the formation model are subsequently affected by the new grain positions. These affected pressures can be determined via fluid-flow model (Box 302) from the determined flow boundary of Box 312.

An exemplary fluid-flow model is discussed below. With respect to a fluid-flow model, in one embodiment, various equations of fluid motion, such as the Navier-Stokes equations, are solved to obtain fluid-pressure/velocity fields (Box 404). In one embodiment, a fluid flow model uses a lattice-Boltzmann method or other finite difference method to solve Navier-Stokes equations. Initial in-situ stresses, pore pressure and rock mechanical properties in the formation model can be provided from drilling information, well logs and rock mechanical test results. Simulations can be performed at a fixed fluid pressure gradient between the inner and outer boundaries of the formation and at a fixed saturation condition, or pressure and saturation fields that vary over the time span of the simulation.

The total hydrodynamic force Fᵢ^{h} acting on each grain in Eq (1) can be determined (Box 406) from pressure and velocity fields using:

Fᵢ^{h}=∫ₛ(pI+η(∇u+(∇u)^{T}))·n dS Eq. (2)

where u and p are the fluid velocity and pressure, determined from the fluid-flow model; S is the interface of the grain and pore space; I is a unit tensor; n is a unit normal vector of a grain-pore interface, and η is a fluid viscosity. The hydrodynamic forces can then be used in the grain-transport model (308) to determine grain positions (310) via Eq. (1), for example.

In general, a flow of fluid through a formation loads the formation matrix, and this loading is carried in turn by individual sand grains and the interstitial material binding them together. From iterations, pore pressure distribution associated with various production conditions can be determined. The associated fluid-induced forces can then be incorporated into a sand prediction model.

In one embodiment, the exemplary interaction between a grain-scale formation model and a fluid flow of FIG. 3 is solved simultaneously using an iterative coupled scheme to obtain a value for sand production volume. Stress and strain distributions near formation cavities are determined. Grains with low contact force magnitudes are swept out of the formation, and their propagation through the cavities results in more grains being disengaged from the formation. The number of grains which move with the fluid out of the formation and into perforation tunnels and/or the borehole are determined as a function of various parameters such as time, stresses, and hydrocarbon flow rate, and completion schemes. A sand production volume and rate is calculated by integrating the sizes and volumes of grains transported by the fluid into the borehole (Box 315). This calculation can be performed under different in-situ conditions.

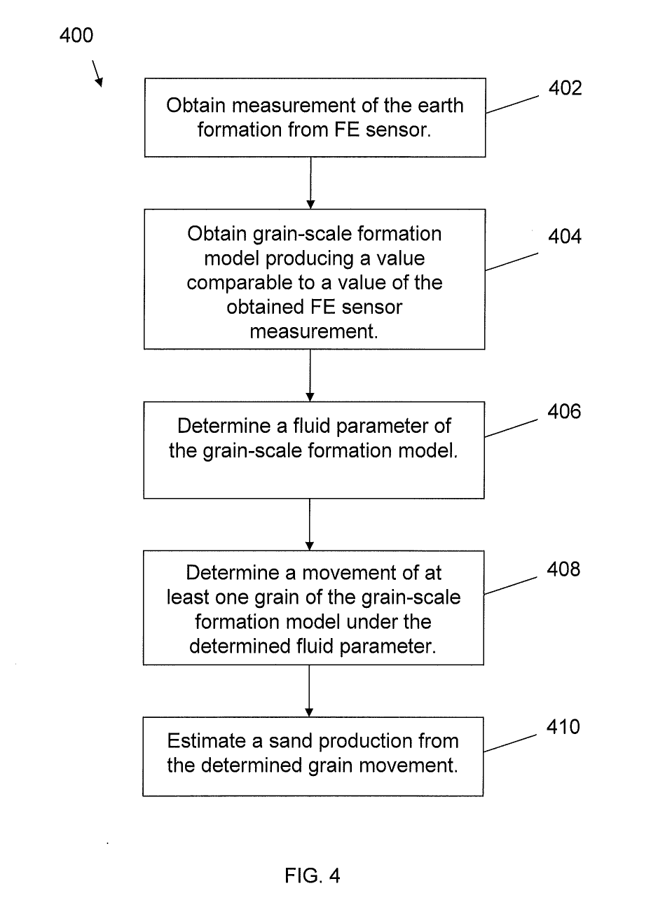

FIG. 4 shows an exemplary flowchart 400 for determining a rate and volume of sand production. In Box 402, a measurement is obtained of the earth formation. In Box 404, a grain-scale formation model is obtained that produces a value of a property that compares to the measurement value obtained at the formation. In Box 406, various fluid parameters are determined in the grain-scale formation model. The exemplary fluid parameters may be due to an applied pressure or a saturation condition. In Box 408, a movement of at least one grain of the grain-scale formation model is determined for the fluid parameter. From the determined grain movements, an estimation of sand production is made in Box 410 for the formation model. The method of estimating sand production can be directed towards selecting a sand control mesh size/gravel size that can in one embodiment minimize sand production with reduced impact on fluid productivity.

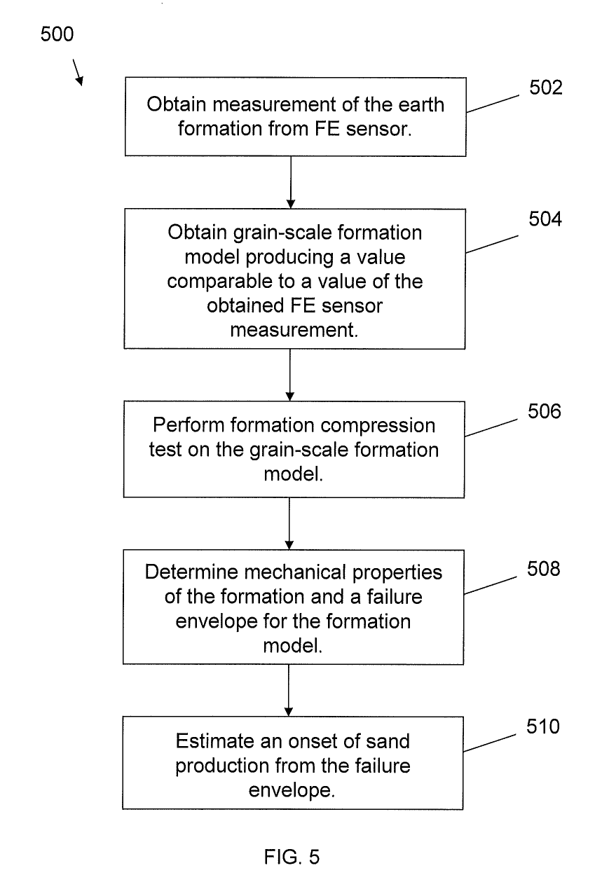

FIG. 5 shows an exemplary flowchart 500 for determining an onset of sand production. In Box 502, a measurement is obtained of the earth formation. In Box 504, a grain-scale formation model is obtained that produces a value of a property that compares to a measurement value obtained at the formation. The grain-scale formation model is typically the same as obtained in the flowchart of FIG. 4. In Box 506, a compression test is performed on the grain-scale formation model, and in Box 508, mechanical properties of the formation and a formation failure envelope are obtained. From the formation failure envelope, an estimation of an onset of sand production is made in Box 510.

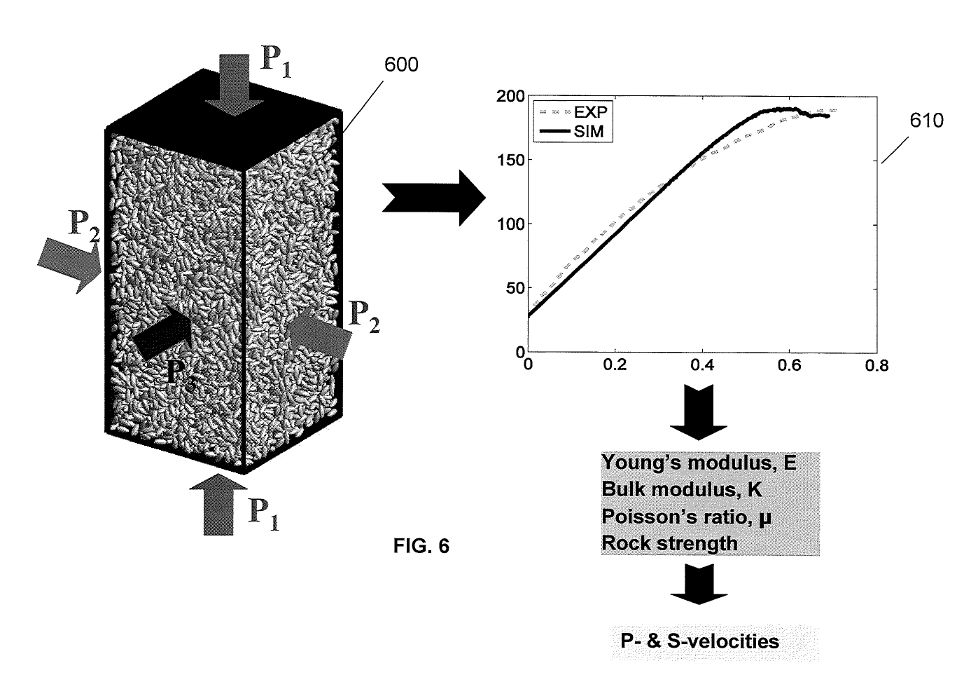

FIG. 6 shows an exemplary formation model 600 for determining an onset of sand production using for example the method of FIG. 5. Pressures P₁, P₂ and P₃ are applied to the formation model. As a result a stress-strain curve 610 can be obtained for the formation model. From the stress-strain curve, various formation properties can be obtained, such as Young's modulus (E), a bulk modulus (K), Poisson's ratio (μ) and rock strength, for example. In addition, compression wave and shear wave velocities can be determined. Such information can be used to determine breaking of cementation bonds and therefore the onset of sand production. The formation of shear bands can be simulated within the formation model.

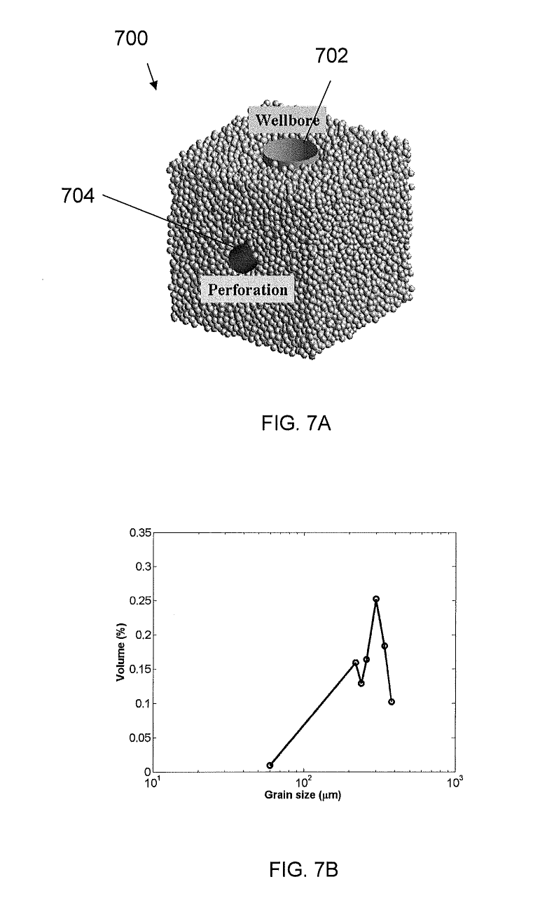

FIG. 7A shows an exemplary three-dimensional model 700 of a formation for determining a sand production size distribution. The model 700 includes a wellbore 702 and a perforation 704. Periodic boundary conditions are used in the horizontal direction, so that grains are arranged infinitely along the horizontal direction. In one embodiment, a borehole and perforations can be introduced into the formation model. In another embodiment, the formation model can have grains of various sizes and shapes. In yet another embodiment, the formation model can include gravel packing, stand alone screen or other sand control schemes. The model 700 can be subjected to both horizontal and vertical flow. As a result, small sand grains can migrate through the formation model 700. FIG. 7B shows a chart of grain size distribution obtained for the exemplary model 700. The exemplary chart shows a peak of sand volume production in a grain size region of about 200 to 400 micrometers. Hence, a suitable screen can be selected according to these characteristic grain sizes.

In another embodiment, the present disclosure provides a three-dimensional formation model that provides rock mechanical properties, such as strength, Young's modulus and bulk modulus, and an internal friction angle. The formation model can provide an estimation of rock failure including stress and strain distribution and pore pressure distribution. The formation model predicts an onset of sand production as well as sand propagation volumes and rates. These predictions provide criteria for selection of gravel pack/mesh size.

In various aspects, the present disclosure can be used to estimate a sand production from a wellbore. The present disclosure can also be used to complete a well or in wellbore completions.

Therefore, the present disclosure provides in one embodiment a method of estimating sand production from an earth formation, which includes: creating a grain-scale formation model of the earth formation, wherein a value obtained from the grain-scale formation model compares to a value of a measured property of the earth formation; determining a fluid parameter of the grain-scale formation model; determining a movement of at least one grain of the grain-scale formation model due to the determined fluid parameter; and estimating the sand production from the determined movement of the at least one grain. Creating the grain-scale formation model can include selecting a plurality of grain sizes, selecting a plurality of grain shapes and grain mineral compositions, applying a grain sedimentation condition, applying a grain compaction condition, and/or applying a diagenetic transformation. The property of the earth formation can be a porosity of the earth formation, a longitudinal relaxation time (T1) of the formation, a transverse relaxation time (T2) of the formation, a compressional velocity, and/or a shear velocity. Estimating the sand production can include solving a grain-transport model and a fluid-flow model coupled to the grain-transport model. Solving the grain-transport model includes solving an equation of motion to obtain a configuration of grains due to a force. The force can be body force from gravity and other external forces; a contact force at the contacts between grains; a damping force resulting from the movement of the grain in a viscous fluid; and/or a hydrodynamic force from fluid flow. In one embodiment, solving the fluid-flow model includes solving a Navier-Stokes equation to obtain a pressure and a velocity field within the formation model. In one embodiment, the estimated sand production is a function of time, pressure gradient, and/or flow rate. Estimating the sand production includes estimating at least one of i) a number of grains, ii) a size of grains, and iii) a volume of grains. In one aspect, the exemplary method includes selecting a sand control screen from the estimated sand production volume. The sand control screen may be selected to complete a wellbore. The sand control screen may be selected for a particular mesh size or to affect a particular gravel size.

In another embodiment, the present disclosure provides an apparatus for estimating sand production from an earth formation. The exemplary apparatus includes a sensor configured to measure a property of the earth formation and a processor that: creates a grain-scale formation model of the earth formation, wherein a value obtained from the grain-scale formation model compares to a value of the measured property, determines a fluid parameter of the grain-scale formation model, determines a movement of at least one grain of the grain-scale formation model due to the determined fluid parameter, and estimates the sand production from the determined movement of the at least one grain. The processor creates the grain-scale formation model by selecting a plurality of grain sizes, selecting a plurality of grain shapes and grain mineral compositions, applying a grain sedimentation condition, applying a grain compaction condition, or applying a diagenetic transformation. The sensor can be a porosity sensor, a nuclear magnetic resonance sensor, an acoustic sensor, a mineralogy sensor, or a core analysis sensor that obtains at least one of: i) porosity data, and ii) X-ray diffraction (XRD) analysis, for example. The processor solves a grain-transport model and a fluid-flow model coupled to the grain-transport model to estimate the sand production. Solving the grain-transport model can include solving an equation of motion to obtain a configuration of grains due to a force, such as: a body force from gravity and other external forces; contact force at the contacts between grains; damping force resulting from the movement of the grain in a viscous fluid; and/or hydrodynamic force from fluid flow. In one embodiment, the processor solves the fluid-flow model by solving a Navier-Stokes equation to obtain at least one of a pressure and a velocity field of the formation model. A number of grains, a size of grains, and/or a volume of grains in a sand production can be estimated. A sand control screen can be selected from the estimated sand production volume. The sand control screen may be selected to complete a wellbore. The sand control screen may be selected for a particular mesh size or to affect a particular gravel size.

In another embodiment, the present disclosure provides a computer-readable medium having stored thereon instructions that when read by at least one processor enable the at least one processor to perform a method, the method comprising: creating a grain-scale formation model of an earth formation, wherein a value obtained from the grain-scale formation model compares to a value of a measured property of the earth formation; determining a fluid parameter of the grain-scale formation model; determining a movement of at least one grain of the grain-scale formation model due to the determined fluid parameter; and estimating the sand production from the determined movement of the at least one grain.

While the foregoing disclosure is directed to the exemplary embodiments of the disclosure, various modifications will be apparent to those skilled in the art. It is intended that all variations within the scope and spirit of the appended claims be embraced by the foregoing disclosure.

What is claimed is:

1. A method of estimating sand production from an earth formation, comprising:
creating a grain-scale formation model of the earth formation, wherein a value obtained from the grain-scale formation model compares to a value of a measured property of the earth formation;
determining a fluid parameter of the grain-scale formation model;
determining a movement of at least one grain of the grain-scale formation model due to the determined fluid parameter; and
estimating the sand production from the determined movement of the at least one grain.

2. The method of claim 1, wherein creating the grain-scale formation model further comprises at least one of (i) selecting a plurality of grain sizes, (ii) selecting a plurality of grain shapes and grain mineral compositions, (iii) applying a grain sedimentation condition, (iv) applying a grain compaction condition, and (v) applying a diagenetic transformation.

3. The method of claim 1, wherein the property of the earth formation is at least one of (i) porosity of the earth formation, (ii) a longitudinal relaxation time (T1) of the formation, (iii) a transverse relaxation time (T2) of the formation, (iv) a compressional velocity, and (v) a shear velocity.

4. The method of claim 1, wherein estimating the sand production further comprises solving a grain-transport model and a fluid-flow model coupled to the grain-transport model.

5. The method of claim 4, wherein solving the grain-transport model further comprises solving an equation of motion to obtain a configuration of grains due to a force.

6. The method of claim 5, wherein the force further comprises at least one of (i) body force from gravity and other external forces; (ii) contact force at the contacts between grains; (iii) damping force resulting from the movement of the grain in a viscous fluid; and (iv) hydrodynamic force from fluid flow.

7. The method of claim 4, wherein the solving the fluid-flow model further comprises solving a Navier-Stokes equation to obtain a pressure and a velocity field within the formation model.

8. The method of claim 1, wherein the estimated sand production is a function of at least one of (i) time, (ii) pressure gradient, and (iii) flow rate.

9. The method of claim 1, wherein estimating the sand production further comprises estimating at least one of (i) a number of grains, (ii) a size of grains, and (iii) a volume of grains.

10. The method of claim 1, further comprising selecting a sand control screen mesh size and/or gravel size from the estimated sand production volume.

11. An apparatus for estimating sand production from an earth formation, comprising:
a sensor configured to measure a property of the earth formation; and
a processor configured to:
create a grain-scale formation model of the earth formation, wherein a value obtained from the grain-scale formation model compares to a value of the measured property,
determine a fluid parameter of the grain-scale formation model, determine a movement of at least one grain of the grain-scale formation model due to the determined fluid parameter, and
estimate the sand production from the determined movement of the at least one grain.

12. The apparatus of claim 11, wherein the processor is configured to create the grain-scale formation model by performing at least one of (i) selecting a plurality of grain sizes, (ii) selecting a plurality of grain shapes and grain mineral compositions, (iii) applying a grain sedimentation condition, (iv) applying a grain compaction condition, and (v) applying a diagenetic transformation.

13. The apparatus of claim 11, wherein the sensor is selected from: (1) a porosity sensor, (2) a nuclear magnetic resonance sensor, (3) an acoustic sensor, and (4) a mineralogy sensor, a core analysis sensor configured to obtain at least one of: i) porosity data, and ii) X-ray diffraction (XRD) analysis.

14. The apparatus of claim 12, wherein the processor is further configured to solve a grain-transport model and a fluid-flow model coupled to the grain-transport model to estimate the sand production.

15. The apparatus of claim 14, wherein the processor is further configured to solve the grain-transport model by solving an equation of motion to obtain a configuration of grains due to a force.

16. The apparatus of claim 15, wherein the force comprises at least one of (i) body force from gravity and other external forces; (ii) contact force at the contacts between grains; (iii) damping force resulting from the movement of the grain in a viscous fluid; and (iv) hydrodynamic force from fluid flow.

17. The method of claim 14, wherein the processor is further configured to solve the fluid-flow model by solving a Navier-Stokes equation to obtain at least one of a pressure and a velocity field of the formation model.

18. The apparatus of claim 11, wherein the processor is further configured to estimate at least one of (i) a number of grains, (ii) a size of grains, and (iii) a volume of grains the in a sand production.

19. The apparatus of claim 11, wherein the processor is further configured to select a sand control screen mesh size and/or gravel size from the estimated sand production volume.

20. A computer-readable medium having stored thereon instructions that when read by at least one processor enable the at least one processor to perform a method, the method comprising:
creating a grain-scale formation model of an earth formation, wherein a value obtained from the grain-scale formation model compares to a value of a measured property of the earth formation;
determining a fluid parameter of the grain-scale formation model;
determining a movement of at least one grain of the grain-scale formation model due to the determined fluid parameter; and
estimating the sand production from the determined movement of the at least one grain.
